(19) United States
(12) Patent Application Publication
(10) Pub. No.: US 2002/0132132 A1
(43) Pub. Date: Sep. 19, 2002

(54) Method of forming an active-element containing aluminide as stand alone coating and as bond coat and coated article

(76) Inventors: Sudhangshu Bose, Manchester, CT (US); Walter E. Olson, Vernon, CT (US); David N. Duhl, Newington, CT (US)

Correspondence Address: Pratt & Whitney, 400 Main Street, Legal Department-Patent Section, Mail Stop 132-13, East Hartford, CT, 06108, US

(21) Appl. No.: 09/735,223

(22) Filed: Dec. 12, 2000

(51) Int. Cl. B32B 15/00

(52) U.S. Cl. 428/632; 428/655; 428/680; 427/252

(57) ABSTRACT

A process is disclosed for forming an improved aluminide coating which includes one or more oxygen active elements. A metallic substrate is coated with an overlay coating, such as an MCrAl coating, including one or more oxygen active elements such as yttrium, hafnium and silicon, by a conventional overlay process such as low pressure plasma spray. A metal, preferably a Series VIII transition metal such as platinum, is applied to the substrate, for example by electroplating. The substrate is then aluminized, for example by chemical vapor deposition, and is preferably heat treated. A ceramic thermal barrier may also be applied. The present invention provides an active element containing aluminide coating having a more consistent composition and having improved durability, either as a standalone coating or as a bond coat for a subsequently-applied thermal barrier coating.

### BACKGROUND OF THE INVENTION

The present invention relates generally to oxidation and corrosion resistant coatings, and relates more particularly to aluminide coatings containing one or more active elements and improved oxidation and corrosion resistance.

Overlay coatings are widely used in high temperature and/or corrosive environments, for example in gas turbine engines, as a stand alone coating, e.g., to provide high temperature corrosion and oxidation resistance to the underlying substrate, and also as an adherent bond coat for a subsequently-applied ceramic thermal barrier coatings. A typical overlay coating is an MCr, MCrAl or MCrAlY coating, such as a coating disclosed in commonly-owned U.S. Pat. No. 4,585,481 and Reissue No. 32,121, both to Gupta et al. The M is selected from the group including nickel, cobalt and iron or combinations of these elements. The Y typically indicates yttrium but may also include silicon and/or other active elements such as hafnium. Overlay coatings are generally, although not necessarily, applied by plasma spraying. See, e.g., U.S. Pat. Nos. 4,321,311 and 4,585,481 and Reissue No. 32,121. Application of overlay coatings by other applications, including but not limited to, electron-beam physical vapor deposition, chemical vapor deposition, cathodic arc and electroplating are also possible. While the bond coat thickness may vary depending upon the particular component and application, the illustrated bond coat typically has a thickness of less than about 5 mils, although thicker or thinner coatings are also used.

Aluminide coatings are also used in high temperature and/or corrosive environments, for example in gas turbine engines, as a stand alone coating, e.g., to provide high temperature corrosion and oxidation resistance to the underlying substrate, and as an adherent bond coat for a subsequently-applied ceramic thermal barrier coating. Some aluminide coatings also include one or more noble metals, which enhance erosion and/or corrosion resistance. See, e.g., U.S. Pat. No. 5,856,027 to Murphy. Aluminide coatings, including those containing noble metal(s), are traditionally applied by a pack process or by chemical vapor deposition (CVD). In a typical “in pack” process, the article to be coated is usually initially electroplated with a noble metal, and is then placed in a pack containing a source of aluminum, an activator, e.g., halide, and inert materials, e.g., alumina. The pack and article are then heated, forming vapors of the aluminum, which reacts with the nickel or cobalt in the article to form the aluminide. The coatings may be further heat treated to obtain desired coating properties. In a typical CVD process, individual generators produce aluminum vapors, and the vapors are conveyed into a chamber to a heated article to be coated where the vapors condense and react with the nickel or cobalt in the article to form the aluminide.

It is generally accepted that it is difficult to produce active element containing aluminides of consistent quality. It is also generally accepted that it is at least as difficult to consistently produce aluminide coatings containing more than one active element.

Numerous patents describe various overlay and aluminide coating compositions and processes. Exemplary patents are identified below.

U.S. Pat. No. Re 32,121 describes forming an MCrAlY (M including nickel, cobalt or a combination) bond coat by plasma spraying, with the MCrAlY composition including about 0.1-0.7 % silicon, and 0.1-2% hafnium.

U.S. Pat. No. 4,897,315 describes a plasma sprayed NiCoCrAlY overlay, which is then aluminized to form an aluminide coating on the substrate.

U.S. Pat. No. 5,658,614 describes a platinum aluminide (without an MCrAIY) coating formed by electroplating the platinum onto the substrate, and then aluminizing by CVD.

It is a general object of the present invention to provide a coating having improved properties.

It is another object to provide an aluminide coating, and a process for applying an aluminide, having improved durability.

It is still another object to provide a repeatable process for forming active element(s) containing aluminide coatings that produces high quality coatings more consistently.

### SUMMARY OF THE INVENTION

According to one aspect of the invention, a method is disclosed for improving the corrosion and oxidation resistance of a substrate. The method includes providing a superalloy substrate, and an overlay coating including at least one oxygen active element is applied onto the substrate by an overlay step. Platinum or other Series VIII transition metal is applied onto the overlay coating, typically but not necessarily by electroplating. The overlay coating and metal is then aluminized, for example by chemical vapor deposition. A ceramic thermal barrier coating may also be applied. A coated article is also disclosed.

### BRIEF DESCRIPTION OF THE DRAWINGS

FIG. 1 is a photomicrograph of a coating of the present invention, including a ceramic coating.

FIG. 2 is a flow diagram illustrating a preferred process for fabricating the coating of the present invention.

### DETAILED DESCRIPTION OF THE PREFERRED EMBODIMENTS

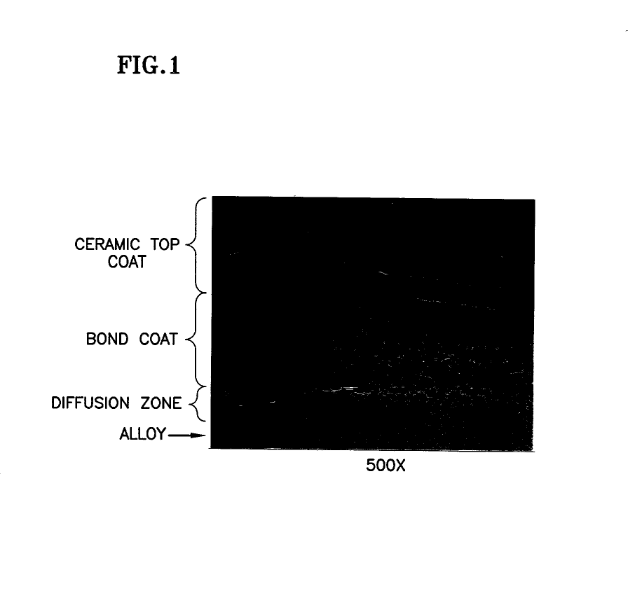

Turning now to FIG. 1, a substrate having an aluminide coating in accordance with the present invention is illustrated by the reference numeral 10. The coating may serve as a stand alone coating, e.g., for high temperature oxidation resistance, or as an adherent bond coat for a subsequently-applied thermal barrier such as a layer of ceramic material, e.g., stabilized zirconia. In the embodiment illustrated in FIG. 1, a ceramic layer is applied over the aluminide to form a thermal barrier. The ceramic layer may be a stabilized zirconia, such as is disclosed in commonly owned U.S. Pat. No. 4,321,311 to Strangman or Ser. No. 09/164,700 to Maloney both of which are commonly owned with the present invention and are expressly incorporated by reference herein.

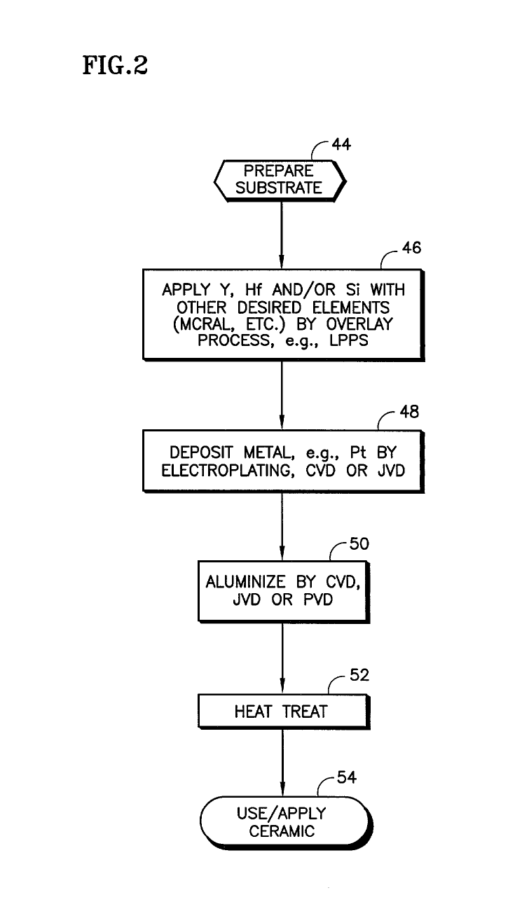

A substrate 12 is typically composed of nickel, cobalt and /or iron base superalloy material. As described further below with reference to FIG. 2, an overlay coating 14 such as an MCrAl type coating is first applied to the substrate, preferably by low pressure plasma spray and together with one or more oxygen active elements such as hafnium, yttrium and silicon or other oxygen active element. A metal, for example a Series VIII transition metal such as platinum is then deposited, preferably by electroplating, and is aluminized to form an adherent alumina layer 16. The article may also be heat treated to provide the coating with desired properties, e.g., improved mechanical properties. As indicated in FIG. 3, the present invention provides coatings having improved properties, e.g., corrosion and oxidation resistance and durability relative to prior coatings. While the invention illustrated below is used with a nickel base, cobalt base or iron base superalloy material, the invention is not limited to use with these materials.

Typical compositions of such alloys are shown in Table 1. Exemplary U.S. Patents describing columnar and single crystal and directionally solidified alloys include U.S. Pat. Nos. 4,209,348; 4,643,782; 4,717,432; 4,719,080 and 5,068,084, each of which is expressly incorporated by reference herein. Cooling holes, which may be positioned on one or more portions of a turbine blade, may be provided for flowing cooling air over the specific portions of the airfoil during operation, as is known generally in the art.

TABLE 1
COMPOSITION OF COLUMNAR AND SINGLE CRYSTAL ALLOYS

| Alloy | Type | Ni | Co | Cr | Al | Mo | Ta | W | Re | Hf | Ti | Nb |
|---|---|---|---|---|---|---|---|---|---|---|---|---|
| PWA 1422 | DS | Bal. | 10 | 9 | 5 | — | — | 12 | — | 1.6 | 2 | 1 |
| DS R80H | DS | Bal. | 9.5 | 14 | 3 | 4 | — | 4 | — | 0.75 | 4.8 | — |
| CM247LC | DS | Bal. | 9.2 | 8.1 | 5.6 | 0.5 | 3.2 | 9.5 | — | 1.4 | 0.7 | — |
| PWA 1480 | SC | Bal. | 5 | 10 | 5 | — | 12 | 4 | — | — | 1.5 | — |
| PWA 1484 | SC | Bal. | 10 | 5 | 5.65 | 1.9 | 8.7 | 5.9 | 3 | 0.1 | — | — |
| Rene' N5 | SC | Bal. | 7.5 | 7 | 6.2 | 1.5 | 6.5 | 5 | 3 | 0.15 | — | — |
| CMSX-4 | SC | Bal. | 9 | 6.5 | 5.6 | 0.6 | 6.5 | 6 | 3 | 0.1 | 1 | — |

Other alloys include, for example, Rene N4 and CMSX-2, which are described in the prior art.

Generally, the active element(s) is applied by a conventional overlay process, and may or may not contain other elements, e.g., as part of an MCr or MCrAl overlay coating. In accordance with the present invention, an overlay coating such as an MCrAl is applied to the substrate surface by a conventional overlay process, such as by low pressure plasma spray. Application of the overlay by other applications is also possible, including but not limited to, electron-beam physical vapor deposition, cathodic arc, electroplating, sputtering and physical vapor deposition. As is known, M indicates nickel, cobalt, iron and mixtures thereof. The bond coat preferably also includes at least one oxygen active element, e.g., yttrium, hafnium, silicon or others. As applied, the present invention preferably includes an overlay coating having a thickness of between about 1-5 mils (0.001-0.005 in.), although coatings of other thicknesses may also be used.

An exemplary overlay coating (described further in an example below) which we have used successfully is a NiCoCrAl coating with added Y, Hf and/or Si. In broad terms, the coating is composed in weight percentage of about 5-40 Cr, 8-35 Al, up to 2 Y, 0.1-7 Si, 0.1-5.5 Hf, balance Ni and/or Co.

One or more Series VII transition metals are then deposited on the MCrAl coating. We believe that the final coating should contain in weight percent about 1-30 of such metal, e.g., Pt, more preferably about 5-20 and as described below we have obtained good results with about 10-11 PT in the final coating. Preferably the metal(s) is deposited by electroplating, in a known manner, but those skilled in the art will recognize that the transition metal may be applied with the application of the overlay coating. Plating the metal to a thickness of about 0.05-0.15 mils should provide a final coating with the above-desired transition metal content. While we prefer to use platinum in connection with the present invention, other metals may also be employed such as palladium, iridium, rhodium, ruthenium and osmium or combinations of these elements. Plating processes are known generally and are not described here in detail. Alternatively, the metal may be applied by jet vapor deposition (JVD), see e.g., U.S. Pat. 4,788,082 and other patents assigned to Jet Process Corporation, which are expressly incorporated herein by reference, by cathodic arc or by CVD.

Aluminum is then applied to the part. While we prefer to use chemical vapor deposition to aluminize the part, jet vapor deposition, physical vapor deposition or other suitable deposition may also be employed. While CVD aluminizing processes are known generally and are not described here in detail, a coating gas has a composition including some amount, in vol. % of a carrier gas, such as hydrogen, and an amount, in vol. %, of an aluminum containing gas. The coating gas may be formed by passing a carrier gas over a source of aluminum. The above process is adjusted as desired to provide a given quantity of aluminum on the part surface. The coating gas is then impinged upon the heated substrate, at a given delivery rate, with the substrate typically being heated to between about 1800-2200 F., and preferably about 1950-2000 F.

After aluminizing, the coated part is diffusion heat treated, although in some cases the diffusion heat treatment may not be necessary. Using the above example, the diffusion heat treatment preferably includes heating the component to a temperature, typically about 1975 F. for a sufficient time, for example about 3 hours, followed by a precipitation heat treatment, for example at about 1600 F. for about 16 hours. The temperatures and times may vary depending upon composition and desired properties with higher temperatures generally associated with shorter times. A resulting coating is illustrated in FIG. 1, which includes a subsequently applied, columnar grain, ceramic thermal barrier layer.

As noted above, coatings in accordance with the present invention may be employed to provide stand alone coatings or bond coats for subsequently-applied ceramic thermal barrier coating. Typical ceramics are zirconia based, and may be partially or fully stabilized with additions of yttria or other appropriate stabilizer. Exemplary ceramic coatings composed of yttria stabilized zirconia (YSZ) are described, for example, in commonly-owned U.S. Pat. Nos. 4,321,311, 5,262,245. The ceramic may be applied by EB-PVD, by plasma spray or by another suitable method.

Samples were prepared using superalloy substrates in accordance with the present invention and some were also coated with a standard, zirconia based columnar ceramic thermal barrier coating. The overlay coating as described above was applied by low pressure plasma spray, and then plated with platinum in a known manner. The samples were aluminized using a coating gas included about 80 vol. % of a carrier gas, such as hydrogen, and about 20 vol. %, of an aluminum containing gas, in this case AlCl₃. The coating gas was formed by passing HCl over a source of aluminum at about 600 C. The coating gas was impinged upon the heated substrate, at a delivery rate of about 224 standard cubic feet per minute, with the substrate heated to a nominal temperature of between about 1950-2000 F. Some of the samples were then coated with a ceramic thermal barrier coating composed of yttria stabilized zirconia, as taught for example in the above referenced '311 patent to Strangman, while other samples were tested without such a ceramic coating.

Coated articles in accordance with the present invention have been tested in a burner rig apparatus. Testing indicated that the present invention coatings, which tests included samples having a subsequently applied thermal insulating layer, are about 2-3 times more durable than current TBC's. The inventive coated articles were also tested as stand alone coatings, e.g., no overlying ceramic layer, and also demonstrate improved protection and durability.

The samples were tested in high temperature burner rigs. The test cycles comprised 117 minute exposure at 2150 degree F. followed by 3 minute air cooling per cycle together with standard platinum aluminides. The samples prepared in accordance with the present invention exhibited improved lives over the samples including the standard aluminides by a factor of about 2.5.

As a result of the testing, we believe that the composition of the final coating in accordance with the present invention is, in weight percent, between about 1-30 Pt, 2-4.5 Si, 13-14 Al, 1-5.5 Hf, remainder Ni, Co, and Cr, and more preferably 10-11 Pt, 2.6-4.2 Si, 13.4-13.6 Al, 3.9-5.3 Hf, remainder Ni, Co, and Cr. Other compositional ranges should also provide for significantly improved lives over known aluminide coatings (with or without a thermal barrier coating).

The present invention provides significant advantages over prior processes. The improved process enables the production of active element containing aluminide coatings having significantly more consistent compositions, and thus significantly more consistent properties and improved durability. The quality of the resulting coatings are thus similarly improved.

While the present invention has been described above in some detail, numerous variations and substitutions may be made without departing from the spirit of the invention or the scope of the following claims. Accordingly, it is to be understood that the invention has been described by way of illustration and not by limitation.

What is claimed is:

1. A method of improving the corrosion and oxidation resistance of a substrate, comprising the steps of:
providing a superalloy substrate;
applying an MCrAl overlay coating including at least one oxygen active element onto the substrate by an overlay step;
applying a Series VIII transition metal onto the overlay coating; and
aluminizing the overlay coating and metal.

2. The method of claim 1, wherein the overlay coating has a nominal composition in weight percent of about 5-40 Cr, 8-35 Al, up to 2 Y, 0.1-7 Si, 0.1-5.5 Hf, balance Ni and/or Co

3. The method of claim 1, wherein the step of applying the overlay coating with the at least one oxygen active element is by a process selected from the group consisting of air plasma spray, low pressure plasma spray, sputtering, cathodic arc, electroplating, and physical vapor deposition.

4. The method of claim 1, wherein the step of applying the transition metal is performed using a process selected from the group consisting of electroplating, jet vapor deposition, physical vapor deposition, sputtering and cathodic arc.

5. The method of claim 1, wherein the step of aluminizing is performed by a process selected from the group consisting of chemical vapor deposition, jet vapor deposition, and physical vapor deposition.

6. The method of claim 1, wherein the Series VIII transition metal is selected from the group consisting of platinum, palladium, iridium, rhodium, ruthenium and osmium.

7. The method of claim 6, wherein the metal is platinum.

8. The method of claim 1, further comprising the step of heat treating the article.

9. The method of claim 1, further comprising the step of depositing a thermally insulating ceramic on the aluminide.

10. The method of claim 1, wherein the ceramic is composed of a stabilized zirconia.

11. A method of improving the oxidation resistance of a substrate, comprising the steps of:
providing a substrate composed of nickel base and/or cobalt base superalloy material;
applying an overlay coating including at least one oxygen active element onto the substrate by low pressure plasma spray;
applying a Series VIII transition metal onto the substrate by electroplating; and
aluminizing the bond coat, at least one oxygen active element and the metal by chemical vapor deposition to form an aluminide on the substrate.

12. The method of claim 11, wherein the overlay coating is also composed of yttrium, hafnium and/or silicon.

13. The method of claim 11, wherein the overlay coating has a nominal composition in weight percent of about 5-40 Cr, 8-35 Al, up to 2 Y, 0.1-7 Si, 0.1-5.5 Hf, balance Ni and/or Co

14. The method of claim 11, wherein the metal is selected from the group consisting of platinum, palladium, iridium, rhodium, ruthenium and osmium.

15. The method of claim 11, wherein the metal is platinum.

16. The method of claim 11, further comprising the step of heat treating the article.

17. The method of claim 11, further comprising the step of subsequently depositing a thermally insulating ceramic on the aluminide.

18. The method of claim 11, wherein the ceramic is composed of a stabilized zirconia.

19. A superalloy article having a coating with improved oxidation and corrosion resistance and durability, made in accordance with the steps of:
providing a superalloy substrate;
applying an overlay coating including at least one oxygen active element onto the substrate by an overlay process;
applying a metal on the overlay coating; and
aluminizing the overlay coating and metal.

20. The article of claim 19, wherein the overlay coating has a nominal composition in weight percent of about 5-40 Cr, 8-35 Al, up to 2 Y, 0.1-7 Si, 0.1-5.5 Hf, balance Ni and/or Co.

21. The article of claim 19, wherein the step of applying the at least one oxygen active element is by a process selected from the group consisting of air plasma spray, low pressure plasma spray, sputtering, cathodic arc, physical vapor deposition and electroplating.

22. The article of claim 19, wherein the step of applying the metal by a process selected from the group consisting of electroplating, jet vapor deposition, and physical vapor deposition.

23. The article of claim 19, wherein the step of aluminizing is performed by a process selected from the group consisting of chemical vapor deposition, jet vapor deposition, and physical vapor deposition.

24. The article of claim 19, wherein the metal is a Series VIII transition metal selected from the group consisting of platinum, palladium, iridium, rhodium, ruthenium and osmium.

25. The article of claim 19, wherein the metal is platinum.

26. The article of claim 19, further comprising the step of heat treating the article.

27. The article of claim 19, further comprising the step of depositing a thermally insulating ceramic on the aluminide.

28. The article of claim 19, wherein the ceramic is composed of a stabilized zirconia.

29. The article of claim 28, wherein the zirconia is stabilized by yttria or by gadolinia.

30. The article of claim 1 wherein the resulting coating has a nominal composition in weight percent of about 5-40 Cr, 8-35 Al, 5-20 Series VIII transition metal, up to 2 Y, 0.1-7 Si, 0.1-5.5 Hf, balance Ni and/or Co.

31. The article of claim 30, wherein the coating has a nominal composition of about 9-12 Pt, 13-14 Al, 3.9-5.5 Hf, 2.5-4.5 Si, balance Ni, Co and Cr.

32. The method of claim 1, wherein the resulting coating has a nominal composition in weight percent of about 5-40 Cr, 8-35 Al, 5-20 Series VIII transition metal, up to 2 Y, 0.1-7 Si, 0.1-5.5 Hf, balance Ni and/or Co.

33. The method of claim 32, wherein the coating has a nominal composition of about 9-12 Pt, 13-14 Al, 3.9-5.5 Hf, 2.5-4.5 Si, balance Ni, Co and Cr.
